(19) United States
(12) Patent Application Publication
(10) Pub. No.: US 2016/0127601 A1
(43) Pub. Date: May 5, 2016

(54) IMAGE-FORMING APPARATUS AND IMAGE-FORMING METHOD

(71) Applicant: KYOCERA Document Solutions Inc., Osaka (JP)

(72) Inventor: Kentaro Kishida, Osaka (JP)

(21) Appl. No.: 14/927,323

(22) Filed: Oct. 29, 2015

(30) Foreign Application Priority Data
Oct. 31, 2014 (JP) 2014-222691

(51) Int. Cl. H04N 1/32; H04N 1/00; G06F 3/12

(52) U.S. Cl. CPC H04N 1/3263; G06F 3/1207; G06F 3/1234; G06F 3/1259; H04N 1/00631; H04N 1/0057; H04N 2201/0094

(57) ABSTRACT

An image-forming apparatus includes a paper jam detection portion, a paper jam processing portion, an image rereading control portion, and an image re-forming control portion. When images are formed based on image data on documents, the paper jam detection portion detects whether a paper jam occurs or not during the forming of the images. When the paper jam is determined to occur as a result of the determination, the paper jam processing portion prompts a user to cause reading of image data on printed matters. The image rereading control portion reads pieces of the image data on the printed matters placed in an automatic document feed portion. The image re-forming control portion checks the pieces of the image data on the printed matters against corresponding pieces of the image data on the documents and to re-form an image based on an unmatched piece of the image data on the document.

### INCORPORATION BY REFERENCE

This application is based upon and claims the benefit of priority from the corresponding Japanese Patent Application No. 2014-222691 filed on Oct. 31, 2014, the entire contents of which are incorporated herein by reference.

### BACKGROUND

The present disclosure relates to an image-forming apparatus and an image-forming method.

In recent years, image-forming apparatuses, such as copying machines and multifunction peripherals, have been introduced that can resume subsequent page printing without causing duplication and lack of pages when a paper jam occurs. For example, in the related art, a printer is disclosed that includes a printer engine portion, a memory device, and an operation panel, wherein the printer engine portion generates print output information on the basis of print input information, including letters, figures, images, and formats, which has been input from an external device, and then prints the generated print output information; and the memory device stores therein the print input information. This printer is provided with a controller that stores the print output information in units of pages in the memory device. Upon occurrence of a paper jam, the controller recognizes printed sheets that are normally output to the output tray of the printer engine portion. The controller then displays, on the operation panel, the print output information on the pages of the printed sheets. In another related art, an image-processing apparatus is disclosed that identifies a sheet left in a sheet conveying system when the sheet has become stuck in the sheet conveying system, prompting an operator to remove this sheet while displaying a thumbnail image of the sheet on the display. This apparatus further displays the last sheet correctly processed or the first sheet to be processed after the removal of the stuck sheet.

### SUMMARY

An image-forming apparatus according to an aspect of the present disclosure includes a paper jam detection portion, a paper jam processing portion, an image rereading control portion, and an image re-forming control portion. When images are formed based on image data on documents, the paper jam detection portion detects whether a paper jam occurs or not during the forming of the images. When the paper jam is determined to occur as a result of the determination, the paper jam processing portion prompts a user to cause reading of image data on printed matters. The image rereading control portion reads pieces of the image data on the printed matters placed in an automatic document feed portion. The image re-forming control portion checks the pieces of the image data on the printed matters against corresponding pieces of the image data on the documents and to re-form an image based on an unmatched piece of the image data on the document.

An image-forming method according to another aspect of the present disclosure includes a paper jam detecting step, a paper jam processing step, an image rereading control step, and an image re-forming control step. The paper jam detecting step includes a step of, when images are formed based on image data on documents, detecting whether a paper jam occurs or not during the forming of the images. The paper jam processing step includes a step of, when the paper jam is determined to occur as a result of the determination, prompting a user to cause reading of image data on printed matters. The image rereading control step includes a step of reading pieces of the image data on the printed matters that are placed in an automatic document feed portion. The image re-forming control step includes a step of checking the pieces of the image data on the printed matters against corresponding pieces of the image data on the documents and re-forming an image based on an unmatched piece of the image data on the document.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a conceptual diagram showing an entire internal configuration of a multifunction peripheral according to the present disclosure.

FIG. 2 is a functional block diagram of the multifunction peripheral in an embodiment of the present disclosure.

FIG. 3 is a flowchart for showing a procedure of executing the embodiment of the present disclosure.

FIG. 4A is a diagram illustrating the relation among paper sheets at the time when a paper jam occurs in the embodiment of the present disclosure, and

FIG. 4B is a diagram illustrating the relation of whether paper sheets are to be discarded at the time when a paper jam occurs.

FIG. 5A is a diagram illustrating a first example of the checking between the image data on documents and the image data on printed matters in the embodiment of the present disclosure, and FIG. 5B is a diagram illustrating a second example of the checking between the image data on documents and the image data on printed matters in the embodiment of the present disclosure.

### DETAILED DESCRIPTION

With reference to the accompanying drawings, a description will be given below of an embodiment of an image-forming apparatus and an image-forming method in the present disclosure, for the sake of understanding the present disclosure. The embodiment that will be described below is a concrete example of the present disclosure and thus not intended to limit the technical scope of the disclosure. In the flowcharts, the alphabetic characters “S” marked on the left of numeric characters refer to process steps.

In the following, an image-forming apparatus will be described as one example of the embodiment in the present disclosure. The image-forming apparatus in the present disclosure corresponds to a multifunction peripheral (MFP) equipped with the functions, for example, of a facsimile, a copier, a scanner, a printer, and the like.

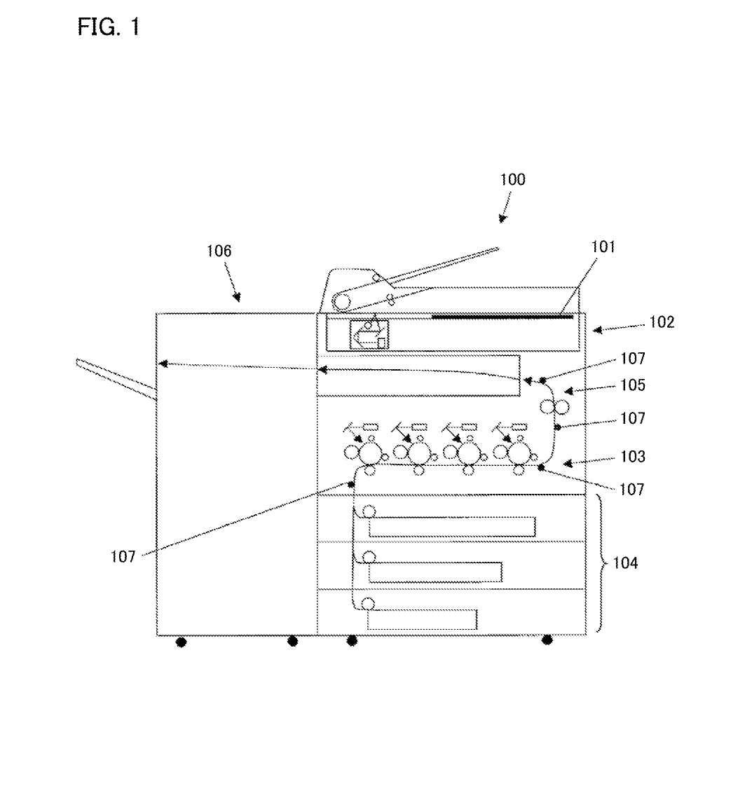

As illustrated in FIG. 1, a multifunction peripheral 100 includes an operating portion 101 having a touch panel, an image reading portion 102, an image-forming portion 103, a paper feed portion 104, a fixing portion 105, a postprocessing portion 106, and paper sheet presence sensors 107. The operating portion 101 receives setting conditions for a predetermined job from a user. The image reading portion 102 reads image data from a document placed on a document table or in an automatic document feed portion. The image-forming portion 103 forms a toner image over a predetermined paper sheet on the basis of the image data. The paper feed portion 104 pulls out a paper sheet from a predetermined one of a plurality of paper feed stages and conveys this paper sheet to the image-forming portion 103. The fixing portion 105 fixes a toner image formed over a paper sheet, thereby producing a printed matter. The postprocessing portion 106 arranges a plurality of printed matters thus produced and subjects those printed matters to a post-process, such as punching or stapling. Each paper sheet presence sensor 107 detects the presence of a paper sheet or a printed matter at a predetermined site in the transport path therefor.

A control circuit (not illustrated) in the multifunction peripheral 100 connects a CPU (Central Processing Unit), a ROM (Read Only Memory), a RAM (Random Access Memory), an HDD (Hard Disk Drive), and drivers corresponding to individual driving portions by using an internal bus.

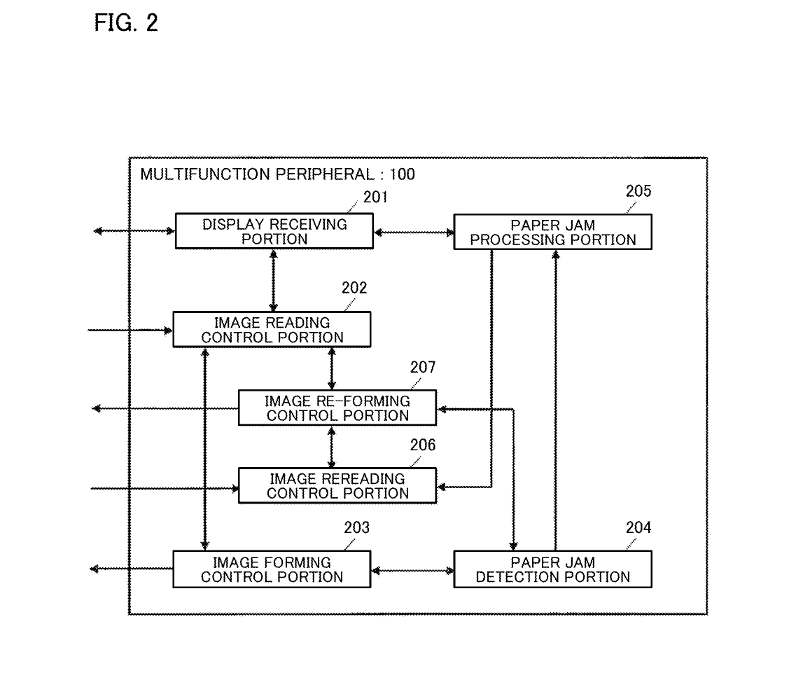

The CPU in the multifunction peripheral 100, for example utilizes the RAM as its working area to execute programs stored in the ROM, the HDD and the like. Then, the CPU exchanges data, instructions, signals, commands, and the like with the drivers based on the execution results and controls the operations of the driving portions which are related to the execution of print jobs. In addition, the CPU executes respective programs to achieve respective portions (shown in FIG. 2 and to be described later) other than the driving portions. The ROM, the RAM, the HDD, and the like store programs and data that implement the respective portions that will be described later.

In the case of occurrence of stuck of a sheet of a page (printed matter) in the multifunction peripheral 100, if the user needs to check the sheet to discriminate between pages printed properly and those not printed properly, and if the user needs to input the pages not printed properly through the operation panel, the user disadvantageously will faces inconvenience or trouble. In contrast, even in the case of occurrence of a paper jam, the multifunction peripheral 100 can easily print pages coming after the paper jam.

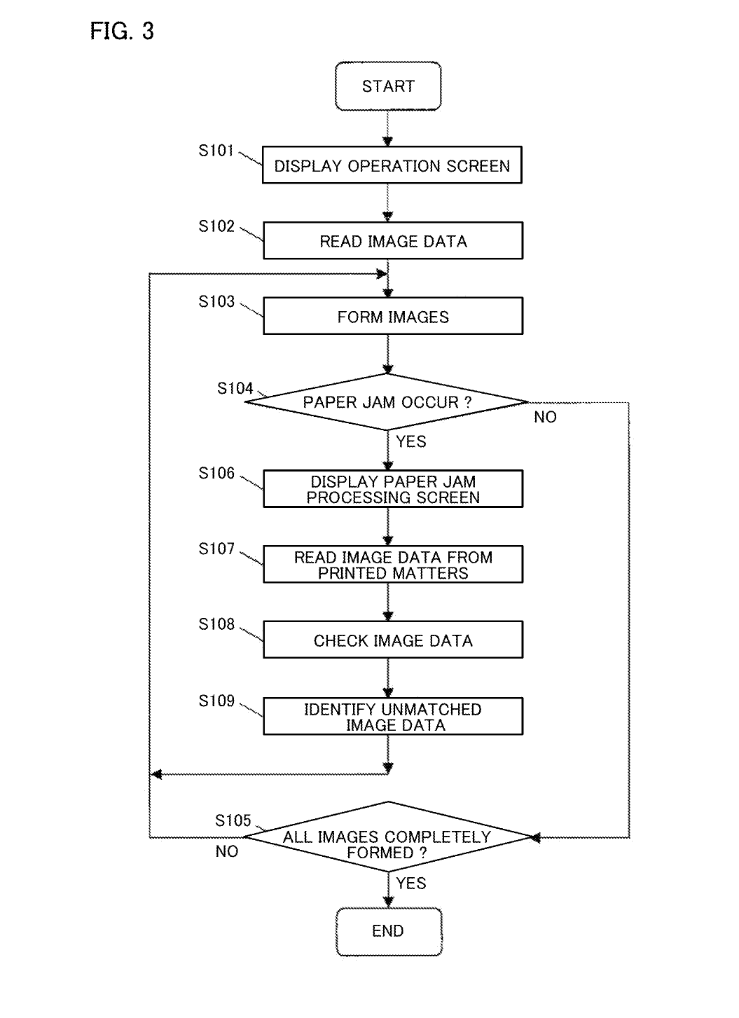

Next, the configuration and execution procedure according to the embodiment of the present disclosure will be described with reference to FIGS. 2 and 3. First, when a user starts up the multifunction peripheral 100, a display receiving portion 201 in the multifunction peripheral 100 displays an operation screen on the touch panel in the operating portion 101 to receive an entry of a user's instruction (FIG. 3: S101).

Here, while viewing the operation screen, the user places a plurality of documents in the automatic document feed portion, then enters predetermined setting conditions, such as the size of the paper sheets and one-side printing, and selects a start key. In response, the display receiving portion 201 accepts the setting conditions and reports the acceptance of the setting conditions to an image reading control portion 202. Upon reception of this report, the image reading control portion 202 reads image data from the documents by using the image reading portion 102 (FIG. 3: S102).

After reading the image data from the documents, the image reading control portion 202 temporarily stores the read image data in a predetermined memory, and reports the reading and storing of the image data to an image-forming control portion 203. Upon reception of this report, the image-forming control portion 203 forms images based on the image data by using the image-forming portion 103, the paper feed portion 104, the fixing portion 105, and the postprocessing portion 106 (FIG. 3: S103).

When starting to form the images, the image-forming control portion 203 reports the forming of the images to a paper jam detection portion 204. Upon reception of this report, the paper jam detection portion 204 detects whether or not a paper jam has occurred during the forming of the images (FIG. 3: S104).

There is no specific limitation on a detection method employed by the paper jam detection portion 204. For example, the paper jam detection portion 204 may detect whether or not paper sheets or printed matters are stuck in a transport path by using the plurality of paper sheet presence sensors 107 preinstalled in the transport path for paper sheets or printed matters, thereby detecting whether the paper jam has occurred. When a specific paper sheet presence sensor 107 constantly detects a paper sheet or printed matter while the image formation control portion 203 is forming the images, the paper jam detection portion 204 determines that the paper jam occurs.

Here, when forming image, the image-forming control portion 203 obtains a piece of image data from image data stored in the memory in the order of reading, and causes the image-forming portion 103 to form a toner image corresponding to the piece of image data thus obtained. Further, the image-forming control portion 203 pulls out a paper sheet in conformity with the setting conditions from the paper feed portion 104 and forms the toner image over the paper sheet. Following this, the image-forming control portion 203 produces a printed matter by fixing the toner image to the paper sheet with the fixing portion 105, which then outputs the printed matter to the postprocessing portion 106. In this way, the image corresponding to the piece of image data is formed.

When the image corresponding to the piece of image data is formed (FIG. 3: S103), if the detection result indicates that no paper jam has occurred at S104 (FIG. 3: NO in S104), the paper jam detection portion 204 reports the detection result to the image-forming control portion 203. In response, the image-forming control portion 203 determines whether all the images have been completely formed (FIG. 3: S105).

There is no specific limitation on the determination method employed by the image-forming control portion 203. For example, the image-forming control portion 203 determines whether a piece of image data that has not yet been subjected to image forming is present or not in the read image data.

If the above determination result indicates that all the images have not been completely formed (FIG. 3: NO in S105), the image-forming control portion 203 returns to S103 and forms images (FIG. 3: S103). In addition, the paper jam detection portion 204 detects whether a paper jam occurs or not (FIG. 3: S104).

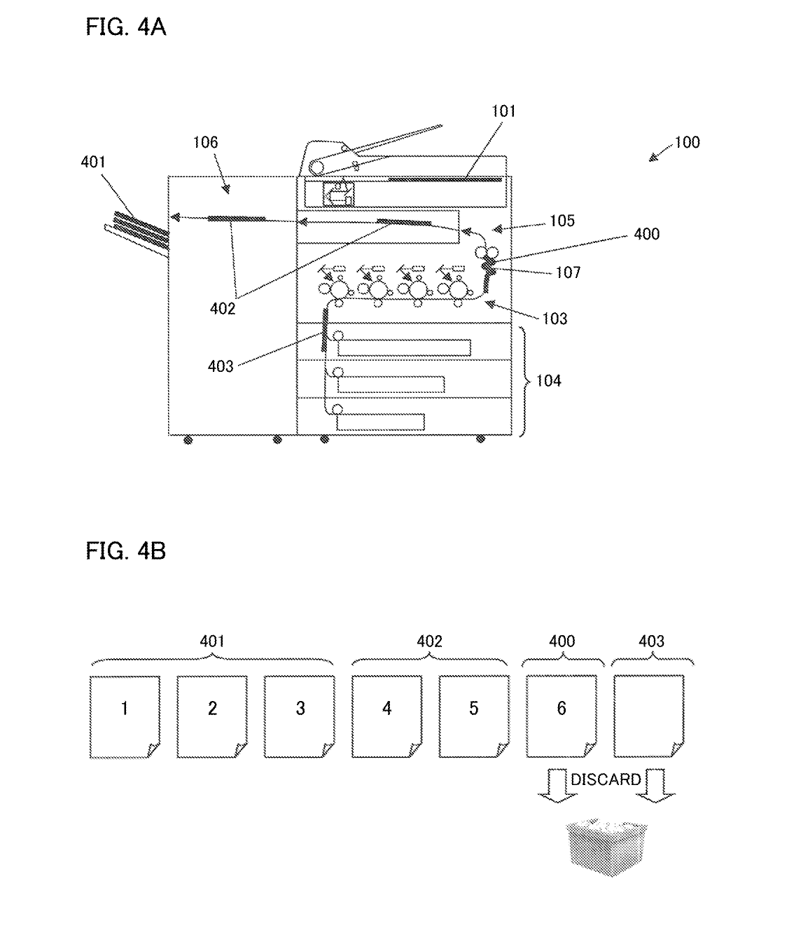

When a paper sheet 400 is stuck on the near upstream side of the fixing portion 105 for some reason, as illustrated in FIG. 4A and thus a paper jam occurs at S104, the following processing will be performed. When detecting the occurrence of the paper jam (FIG. 3: YES in S104), the paper jam detection portion 204 reports the detection result to a paper jam processing portion 205. Upon reception of this report, the paper jam processing portion 205 displays a predetermined paper jam processing screen on the touch panel in the operating portion 101, prompting the user to cause reading of image data from printed matters (FIG. 3: S106).

Here, there is no specific limitation on the encouraging method employed by the paper jam processing portion 205. For example, the paper jam processing portion 205 displays messages on the paper jam processing screen, one of which indicates that a paper jam has occurred and the other of which prompts the user to cause reading of image data from printed matters with the images formed thereon. The expression “printed matters with the images formed thereon” implies printed matters 401 and 402, as illustrated in FIG. 4A. The printed matters 401 have images completely formed thereon and are stacked on a predetermined tray in the postprocessing portion 106; whereas the printed matters 402 had passed through the fixing portion 105 at the time of the occurrence of the paper jam and are present inside the multifunction peripheral 100. A paper sheet 400 subjected to the paper jam and a paper sheet 403 following the paper sheet 400 subjected to the paper jam, such as a paper sheet that has been simply fed (or undergone only a toner image transfer), do not correspond to the printed matters 401 with images completely formed thereon, because images have not been completely formed.

As illustrated in FIG. 4B, when the paper jam occurs, the printed matters 401 ejected from the multifunction peripheral 100, the printed matters 402 that have passed through the fixing portion 105 and are left inside the multifunction peripheral 100, the paper sheet 400 subjected to the paper jam, and the paper sheet 403 positioned upstream of the fixing portion 105 are present as the state of paper sheets. One of the printed matters 402 with the image printed thereon which is being conveyed inside the multifunction peripheral 100 at the instant of the occurrence of the paper jam is not a target to be discarded. Another one of the printed matters 402 which has passed through the fixing portion 105 at the instant of the occurrence of the paper jam and is left inside the multifunction peripheral 100 is equivalent to a normal printed matter with image formed thereon. For this reason, these printed matters were not involved in the paper jam and have no damage, and thus can be regarded as normal printed matters after being removed from the multifunction peripheral 100. The paper sheet 400 involved in the paper jam and the paper sheet 403 positioned upstream of the fixing portion 105 are to be discarded and then to be printed again. The paper sheet 403 that has been simply fed may be returned to the paper feed stage again.

The paper jam processing portion 205 displays, in the paper jam processing screen, a screen in which the site of the paper jam is pinpointed and a message indicating how to deal with the paper jam, thereby prompting the user to clear the paper jam. The user clears the paper jam by removing the paper sheet 400 stuck in the multifunction peripheral 100 therefrom while seeing the paper jam processing screen. After the paper jam has been cleared, the paper jam processing portion 205 ejects paper sheets present inside the multifunction peripheral 100 to the tray of the postprocessing portion 106. Examples of the ejected paper sheets are: the printed matter 402 that has passed through the fixing portion 105 at the instance of the occurrence of the paper jam and is left inside the multifunction peripheral 100; and the paper sheet 403 that has been simply fed at the instance of the occurrence of the paper jam. Thus, the user can obtain the printed matters 402 with the image completely formed thereon which have stayed inside the multifunction peripheral 100. Further, the user can make use of the printed matters 402 without wasting them in vain.

After clearing the paper jam, the user places the printed matters 401 and 402 in the automatic document feed portion and then selects an image reading key. Then, the paper jam processing portion 205 receives the selection of the image reading key and reports the reception of the selection of the image reading key to an image rereading control portion 206. Upon reception of this report, the image rereading control portion 206 reads the image data from the above printed matters by using the image reading portion 102 (FIG. 3: S107). After reading the image data from the printed matters, the image rereading control portion 206 temporarily stores the read image data in the memory.

Next, when completing reading the image data, the image rereading control portion 206 reports the completion of reading the image data to an image re-forming control portion 207. Upon reception of this report, the image re-forming control portion 207 checks the image data on the printed matters against the image data on the documents (FIG. 3: S108). Then, the image re-forming control portion 207 re-forms images on the basis of unmatched image data on documents (or image data on documents from which images have not yet been formed).

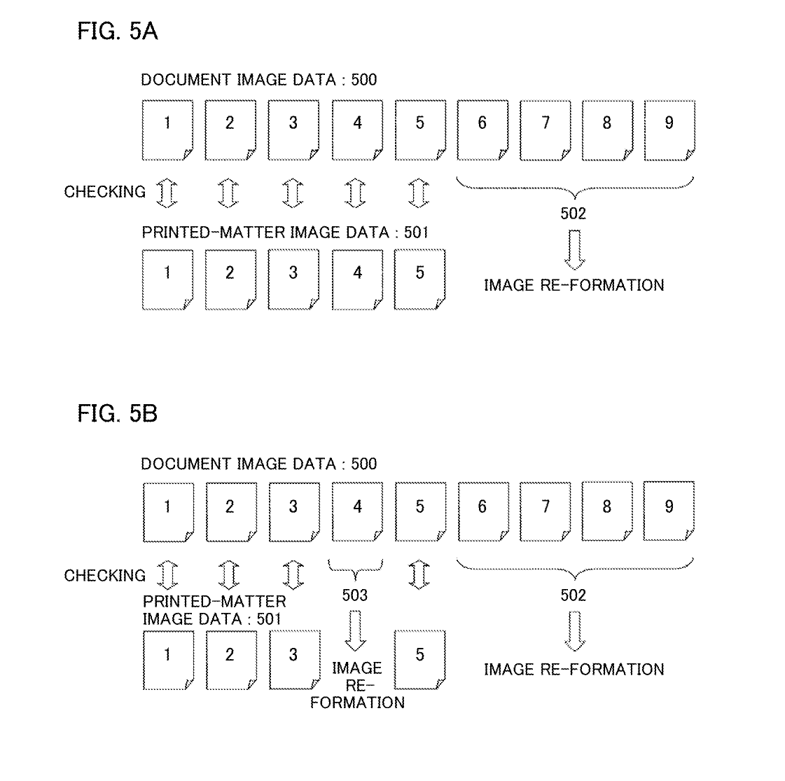

Here, there is no specific limitation on the checking method employed by the image re-forming control portion 207. For example, as illustrated in FIG. 5A, the image re-forming control portion 207 obtains document image data 500 read by the image reading control portion 202 (image data for one job) from the memory, and also obtains printed-matter image data 501 read by the image rereading control portion 206 from the memory. Then, the image re-forming control portion 207 compares the printed-matter image data 501 with the document image data 500 one by one, thereby determining whether both image data match each other.

In determining whether the printed-matter image data 501 matches the document image data 500, the image re-forming control portion 207 may determine whether both image data match each other accurately. For example, the image re-forming control portion 207 may determine whether the image patterns of the document image data 500 match those of the printed-matter image data 501. If both image patterns are determined to match each other as a result of the determination, the image re-forming control portion 207 determines that the printed-matter image data 501 matches the document image data 500. Then, the image re-forming control portion 207 compares a next one of the printed-matter image data 501 and a next one of the document image data 500 that have not been subjected to the checking process. The numbers of printed-matter image data 501 and document image data 500 that are not subjected to the checking process decreases as the checking process is repeated. As a result of repeating the checking process, unmatched document image data 502 is left, because the number of printed-matter image data 501 is smaller than that of document image data 500. The remaining document image data 502 corresponds to image data from which no images have been formed. Therefore, the image re-forming control portion 207 identifies these image data 502 as unmatched image data (FIG. 3: S109). After that, the processing returns to S103, in which images are re-formed on the basis of the image data 502 (FIG. 3: S103). This can automatically distinguish between the image data (pages) having been printed and the image data requiring reprinting even when the paper jam occurs, thereby eliminating the necessity of identifying the image data by the user, as well as a key operation through the operating portion 101.

It is assumed that the image re-forming control portion 207 determines, one by one, whether the printed-matter image data 501 matches the document image data 500, and, for example, the fourth one of the printed-matter image data 503 is lacking for some reason, as illustrated in FIG. 5B. In this case, since there is none of the printed-matter image data 503 that matches the fourth one of the document image data 500, the image re-forming control portion 207 identifies the fourth one of the printed-matter image data 503 as an unmatched one of the image data and as a target for image re-formation. In this way, even if some of the printed matters are lacking for any reason, such lacking printed matters can be reprinted and reproduced easily.

Before reprinting image data, the image re-forming control portion 207 displays a predetermined screen on the touch panel to prompt the user to place the printed matters 401 and 402 in a sheet inserter portion of the postprocessing portion 106. This sheet inserter portion adjusts the order of the existing printed matters 401 and 402 and printed matters to be reprinted. More specifically, the image re-forming control portion 207 adjusts the order of the existing printed matters 401 and 402 in the sheet inserter portion and the printed matters to be reprinted, in accordance with the order of the document image data 500. This can eliminate the need for the user to collate the order of printed matters. Especially, if the order of the existing printed matters 401 and 402 is changed for some reason, the multifunction peripheral 100 is adapted to collate the order and thus can save the trouble of the user.

When reprinting image data, the image re-forming control portion 207 may delete the matched document image data 500 and printed-matter image data 501 from the memory. This can save the usable capacity of the memory.

After the image re-forming control portion 207 has formed an image (FIG. 3: S103), the paper jam detection portion 204 detects whether or not a paper jam occurs in the above-described manner (FIG. 3: S104). If the paper jam is determined to occur (FIG. 3: YES in S104), the processing proceeds to S106 in a similar way to that described above.

Meanwhile, the image re-forming control portion 207 forms the image and then determines whether all the images have been completely formed (FIG. 3: S105). In this case, the image re-forming control portion 207 determines whether there is no image data from which any image is yet to be formed, in the document image data 500 that are unmatched.

If all the images are determined to have been formed as a result of the determination (FIG. 3: YES in S105), the image re-forming control portion 207 deletes the document image data 500 stored in the memory therefrom, whereby all the processes are ended. If no paper jam has occurred (FIG. 3: NO in S104), and all the images have been completely formed (FIG. 3: YES in S105), the image-forming control portion 203 similarly deletes the document image data 500 stored in the memory therefrom, whereby all the processes are ended.

Although the embodiment of the present disclosure has the configuration that prompts a user to cause reading of the printed-matter image data 501 when paper jam occurs, the present disclosure may have another configuration. For example, the paper jam processing portion 205 may prompt the user to read only a piece of image data on the last one of the printed matters 401 and 402. Then, the image re-forming control portion 207 may check the piece of image data on this last one of the printed matter against the document image data in the order of the document image data. Document image data following the piece of the document image data that matches the last piece of the printed image data may be determined as unmatched document image data. This can shorten a process required to read documents or a waiting time therefor.

The embodiment of the present disclosure assumes one-side printing but double-side printing is also applicable. In this case, when checking the printed-matter image data 501 against the document image data 500, the image re-forming control portion 207 determines whether or not there are image data about two printed matters that match two document image data used for both-side printing, in the printed-matter image data 501. When the two printed-matter image data are present, the double-side printing therefor has been completed. Then, the image re-forming control portion 207 does not designate these two document image data as the targets for the image re-formation. On the other hand, when there is no printed-matter image data, or when only one piece of printed-matter image data is present, the both-side printing is not completed. Then, the image re-forming control portion 207 designates the two document image data that do not match these printed-matter image data, as unmatched image data, which are thus to be the targets for image re-formation. Consequently, this can also save the trouble of the user even in the double-side printing.

Although the embodiment of the present disclosure is configured such that the multifunction peripheral 100 is provided with the individual portions, the present disclosure may be configured with a storage medium that stores programs therein for use in implementing the individual portions. This configuration causes the multifunction peripheral to read the program, so that the multifunction peripheral implements each portion. In this case, the program itself read from the recording medium produces the operations and effects of the present disclosure. The embodiment of the present disclosure can also be provided as a method of storing the process steps performed by the individual portions in a hard disk.

As described above, the image-forming apparatus and the image-forming method according to the present disclosure are effective for image-forming apparatuses, including multifunction peripherals and copying machines. Furthermore, the image-forming apparatus and the image-forming method are effective in easily printing pages subsequent to paper jam when the paper jam occurs.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image-forming apparatus comprising:
a paper jam detection portion configured to, when images are formed based on image data on documents, detect whether a paper jam occurs or not during the forming of the images;
a paper jam processing portion configured to, when the paper jam is determined to occur as a result of the determination, prompt a user to cause reading of image data on printed matters;
an image rereading control portion configured to read pieces of the image data on the printed matters that are placed in an automatic document feed portion; and
an image re-forming control portion configured to check the pieces of the image data on the printed matters against corresponding pieces of the image data on the documents and to re-form an image based on an unmatched piece of the image data on the document.

2. The image-forming apparatus according to claim 1, wherein
upon clearance of the paper jam, the paper jam processing portion ejects the printed matter that has passed through a fixing portion and is present inside the apparatus at the time of the occurrence of the paper jam and a paper sheet positioned upstream of the fixing portion at the time of the occurrence of the paper jam.

3. The image-forming apparatus according to claim 1, wherein
the image re-forming control portion checks the pieces of the image data on the printed matters against the corresponding pieces of the image data on the documents by comparing the pieces of the image data on the printed matters with the corresponding pieces of the image data on the documents one by one to determine whether both the image data match each other.

4. The image-forming apparatus according to claim 1, wherein
upon the re-formation, the image re-forming control portion prompts the user to place the printed matters that are in a sheet inserter portion of a postprocessing portion and adjusts an order of the printed matters that are in the sheet inserter portion and the printed matter that is to be reprinted, in accordance with an order of the image data on the documents.

5. The image-forming apparatus according to claim 1, wherein
the paper jam processing portion prompts the user to cause reading of only a piece of the image data on a last one of the printed matters,
the image re-forming control portion checks the piece of the image data on the last printed matter against each piece of the image data on the documents in an order of the image data on the documents, and defines, as a piece of the image data on an unmatched one of the documents, a piece of the image data on a next one of the documents that follows a piece of the image data on the document that matches the piece of the image data on the last printed matter.

6. An image-forming method comprising:
a paper jam detecting step of, when images are formed based on image data on documents, detecting whether a paper jam occurs or not during the forming of the images;
a paper jam processing step of, when the paper jam is determined to occur as a result of the determination, prompting a user to cause reading of image data on printed matters;
an image rereading control step of reading pieces of the image data on the printed matters that are placed in an automatic document feed portion; and
an image re-forming control step of checking the pieces of the image data on the printed matters against corresponding pieces of the image data on the documents and re-forming an image based on an unmatched piece of the image data on the document.
